(19) United States
(12) Patent Application Publication
(10) Pub. No.: US 2012/0234788 A1
(43) Pub. Date: Sep. 20, 2012

(54) Bottle Device

(76) Inventor: Karla Naomi Livingston, Las Vegas, NV (US)

(21) Appl. No.: 12/930,596

(22) Filed: Mar. 16, 2011

(51) Int. Cl. A61J 9/08

(52) U.S. Cl. 215/11.6

(57) ABSTRACT

An apparatus and method for delivery of expressed breast milk to be ingested by a newborn. This is achieved by placing the fully assembled apparatus around the caregiver's neck which allows the apparatus to hang at the chest area of the caregiver and provides the newborn with direct access to the expressed milk through the apparatus. This apparatus replicates the breastfeeding and bonding process between the newborn and the caregiver, be it male or female. This is achieved by adding expressed breast milk into a conical, recycled glass container; attaching the nipple and nipple cap assembly; placing the recycled rubber cover over the glass container holding it in place with the two recycled rubber tabs at the bottom of the recycled rubber cover and delivering the expressed milk to the infant in any upright breastfeeding position.

### FIELD OF THE INVENTION

The present invention relates to bottle devices.' More specifically, the present invention is a baby bottle that is suspended from the neck of the caregiver allowing delivery of expressed breast milk or formula to a newborn.

### BACKGROUND OF THE INVENTION

The prior art in the field of baby bottles does not-provide the caregiver, male or female, the opportunity to replicate breastfeeding in private and public places. Additionally, the prior art fails to address the long touted benefits of breastfeeding to the newborn and the caregiver. For example, see Surgeon General's Perspectives, The 25th Anniversary of the Surgeon General's Workshop on Breastfeeding and the Human Lactation; The Status of Breastfeeding Today as provided by the Public Health Reports May-June 2009, Volume 124 and Breastfeeding: Best for baby; Best for mom from Women's Health

Moreover, the prior art in the field of baby bottles does not acknowledge nor resolve physical limitations of caregivers who want to participate in holding, feeding and bonding with a newborn through the art of breastfeeding. Should the caregiver have a physical malady such as paralysis, drug addiction or any debilitating indices, prior art does not provide a tangible option.

### BRIEF SUMMARY OF THE INVENTION

This invention is comprised of recycled glass that forms a baby bottle shaped like a beaker; a nipple and nipple cap assembly; and a recycled rubber cover with strap that is suspended from the neck of the caregiver and permits a newborn to suckle as though breastfeeding.

This invention includes components that, when assembled, create a baby bottle that is suspended from the neck of a caregiver, allowing the device to rest on the chest of the caregiver and deliver expressed breast milk to a newborn. This device includes a recycled glass receptacle (beaker) with a flat back and a contoured or conical front with an extension having an opening at the top which is threaded to house the nipple and nipple cap assembly. The nipple and nipple cap assembly is threaded onto the extension at the top of the recycled glass receptacle and inserted into a recycled rubber cover which is suspended by a hollow, 36″ recycled rubber strap worn around the neck of the caregiver. The recycled glass receptacle, nipple and nipple cap assembly are inserted into the recycled rubber cover which is secured at the bottom by two recycled rubber tabs.

### BRIEF DESCRIPTION OF THE DRAWINGS

FIG. 1 is a side view of a receptacle according to an embodiment of the present invention;

FIG. 2 is a side view of a nipple and nipple cap assembly according to an embodiment of the present invention;

FIG. 3 is a side view of a cover according to an embodiment of the present invention;

FIG. 4 is a front view of a cover according to an embodiment of the present invention;

FIG. 5 is a rear view of a cover according to an embodiment of the present invention;

FIG. 6 is a front view of a strap according to an embodiment of the present invention.

### DETAILED DESCRIPTION OF THE DRAWINGS

Reference is now made to the figures wherein like parts are referred to by like numerals throughout. Assembly of the relative components are detailed below.

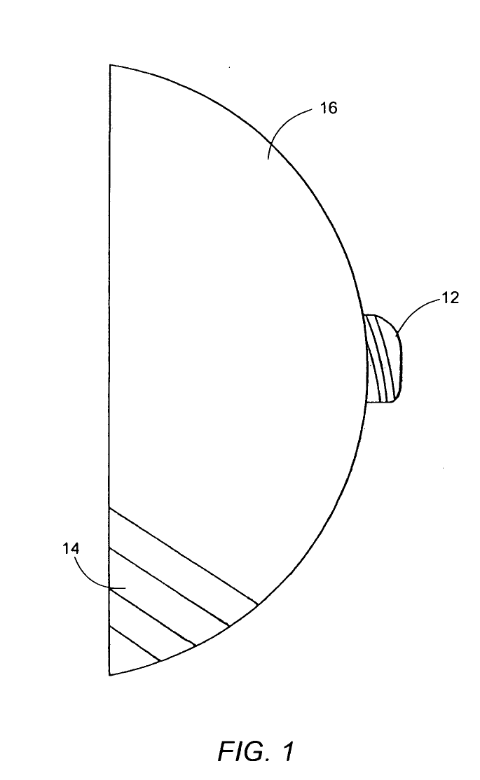

In one optional embodiment, illustrated in FIG. 1, the invention includes a recycled glass receptacle 16 which will store the expressed breast milk for delivery to the newborn. A raised, threaded extension 12 of the glass receptacle 16 engages a nipple 22 and nipple cap assembly 24 (described in greater detail below). A voided area 14 of the glass receptacle 16 reduces excess air intake by the suckling newborn in an effort to reduce indigestion.

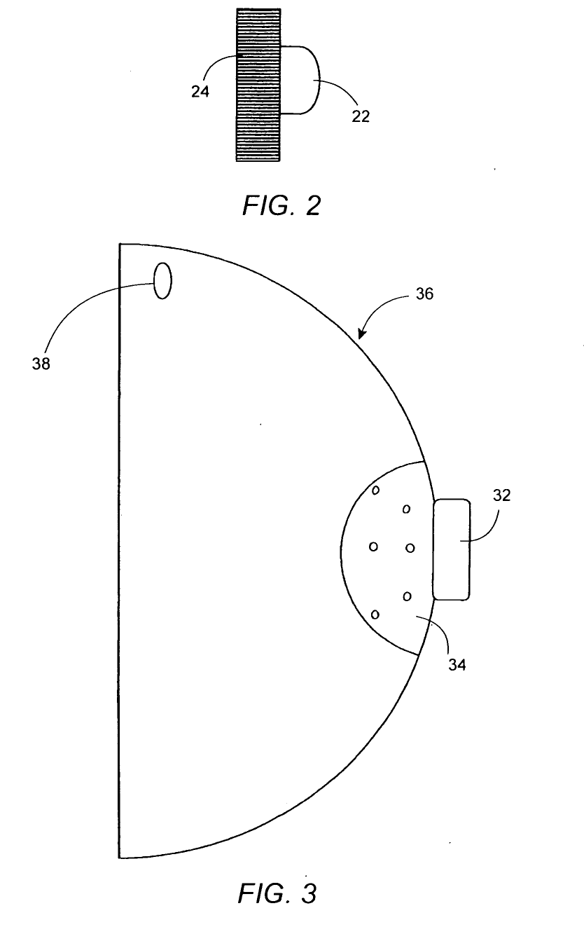

FIG. 2 illustrates a standard rubber nipple 22 and nipple cap assembly 24 generally available in the open market.

FIG. 3 illustrates a side view of the recycled rubber cover 36 that will house the recycled glass receptacle 16, nipple 22 and nipple cap assembly 24. A hollowed, raised recycled rubber mouth 32 of the recycled rubber cover 36 houses the recycled glass receptacle 16, nipple 22 and nipple assembly 24.

A perforated, ventilated section 34 of the recycled rubber cover allows free flow of air while the newborn is suckling to reduce or negate the possibility of suffocation.

A hollowed recycled rubber cover 36 houses the glass receptacle 16.

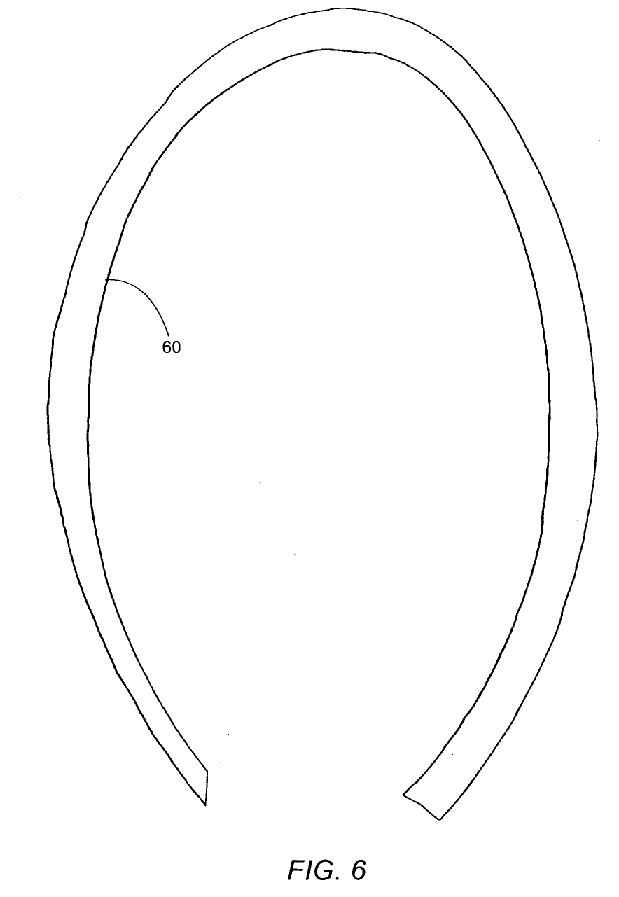

The cover 36 includes two bi-lateral holes 38 through which the recycled rubber neck strap illustrated in FIG. 6 is utilized to suspend the recycled rubber cover 36.

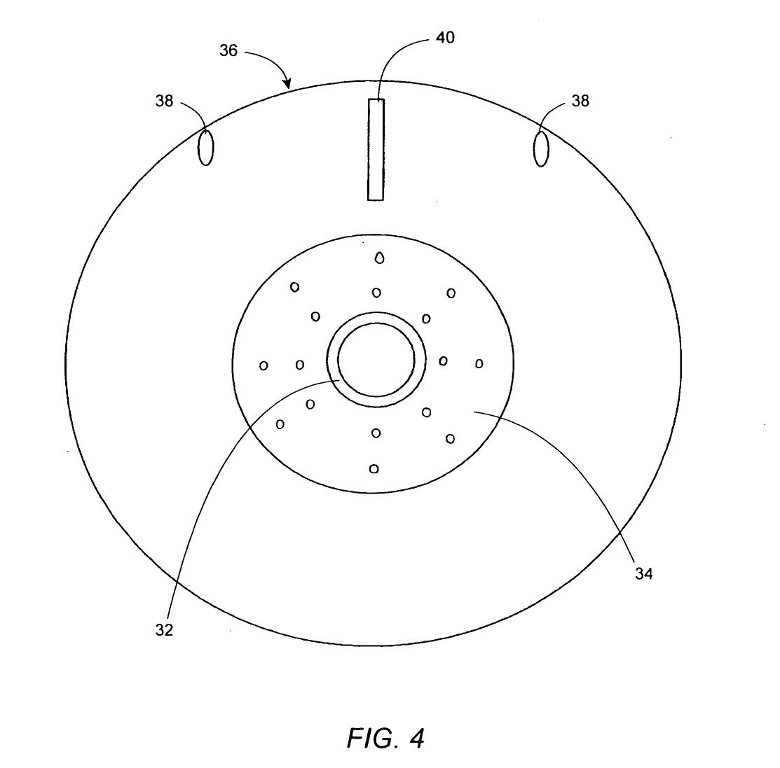

FIG. 4 illustrates a frontal view of the recycled rubber cover 36 that houses the recycled glass receptacle 16, nipple 22 and nipple cap assembly 24, which includes a hollowed slit 40 to monitor liquid intake.

For example, a hollowed slit 40, through which the receptacle 16 can be viewed, allows the caregiver to monitor the volume intake of the newborn.

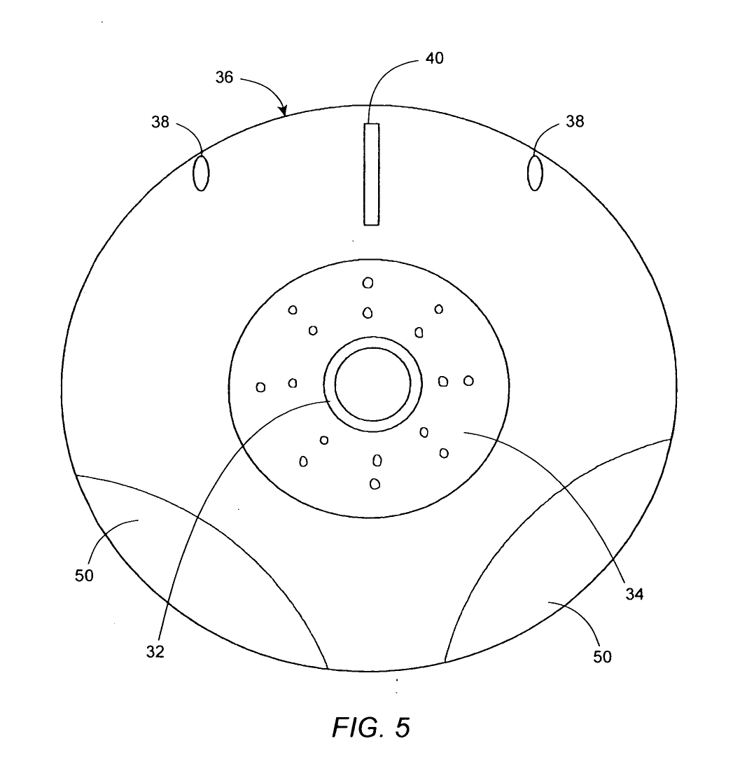

FIG. 5 illustrates an internal view of the recycled rubber cover 36 that will house the recycled glass receptacle 16, nipple 22 and nipple cap assembly 24 and includes bi-lateral tabs 50-at-the-bottom of the recycled rubber cover 36 to secure the recycled glass receptacle 16 inside the cover 36.

More specifically, two rubber tabs 50 at the base of the recycled rubber cover 36 cooperate with the cover to secure the recycled glass receptacle 16 inside the cover 36.

FIG. 6 illustrates a hollowed neck strap 60 that supports the recycled rubber cover 36. In one optional embodiment, the strap 60 may be thirty-six inches long.

The device forms a baby bottle that is suspended from the neck of a caregiver, allowing the receptacle 16 to rest on the chest of the caregiver and deliver expressed breast milk to a newborn. The receptacle 16 is oriented with the flat back toward the caregiver and rounded front directed away from the caregiver and toward the newborn. The nipple 22 and nipple cap assembly 24 is threaded to the extension 12 on the front of the receptacle 16. opening at the top which is threaded to house the nipple and nipple cap assembly. The receptacle 16 with the nipple 22 and nipple cap assembly 24 attached is inserted into the cover 36 with the nipple 22 and nipple cap assembly 24 inside the mouth 32 of the cover 36. The cover 36 is secured to the receptacle 16 by tabs 50. The cover 36, in turn, is suspended by a strap 60 worn around the neck of the caregiver.

The drawings disclose a best mode of the present invention, a tethered baby bottle that encourages breastfeeding of a newborn. While the configurations according to the illustrated embodiments are preferred, it is envisioned that alternate configurations of the present invention may be adapted without deviating from the invention as portrayed.

I claim:

1. A bottle comprising:
a receptacle bounded by a substantially rounded front wall and a substantially flat rear wall, said receptacle including an opening on said front wall surrounded by an extension;
a nipple sized to cover said opening;
a nipple cap assembly mated to said extension, said nipple cap assembly adapted to removably secure said nipple to said opening;
a substantially contoured cover shaped to receive said receptacle, said cover including a raised, substantially hollow mouth receiving said extension, said nipple cap, and said nipple, said cover perforated proximate said mouth, said cover including at least two holes; and
a strap threaded through said holes.

2. The bottle of claim 1 wherein said holes are located at the top of said cover and said cover further comprises a slit proximate the top of said cover through which said receptacle is visible.

3. The bottle of claim 1 wherein said cover includes tabs attached to said substantially rounded cover, said tabs adapted secure said receptacle inside said cover.

4. A bottle comprising:
a receptacle bounded by a substantially rounded front wall and a substantially flat rear wall, said receptacle including an opening on said front wall surrounded by an extension;
a nipple sized to cover said opening;
a nipple cap assembly mated to said extension, said-nipple cap assembly adapted to removably secure said nipple to said opening;
a substantially contoured cover shaped to receive said receptacle, said cover including a raised, substantially hollow mouth receiving said extension, said nipple cap, and said nipple, said cover perforated proximate said mouth, said cover including at least two holes, said holes defining the top of said cover, said cover including a slit proximate said top of said cover through which said receptacle is visible, said cover including tabs attached to said cover, said tabs adapted secure said receptacle inside said cover; and
a strap threaded through said holes.
